(19) United States
(12) Patent Application Publication
(10) Pub. No.: US 2013/0250185 A1
(43) Pub. Date: Sep. 26, 2013

(54) Head Mounted Display

(71) Applicant: Dan Sarmiento, Palmetto, FL (US)

(72) Inventor: Dan Sarmiento, Palmetto, FL (US)

(21) Appl. No.: 13/673,788

(22) Filed: Nov. 9, 2012

Related U.S. Application Data
(60) Provisional application No. 61/613,546, filed on Mar. 21, 2012.

(51) Int. Cl. G02B 27/01; H04N 9/31

(52) U.S. Cl. CPC G02B 27/0172; H04N 9/3173
USPC 348/789; 345/8

(57) ABSTRACT

A head mounted display system comprising a hollow support structure having an opening for insertion of a user head has a forward faceplate integrated with a front of the hollow support structure and a light projection device connected to the hollow support structure such that the light projection device displays an image on the forward faceplate when activated. There is a circuit device attached to the hollow support structure and in communication with the light projection device. An audio device is also attached and it is also is in with a circuit device. The forward faceplate is a matte screen or a shutter device that responds to electric signals to present a holographic type floating image when the shutter opens and a solid image when closed.

### CROSS REFERENCE TO RELATED APPLICATIONS

The instant application claims benefit of earlier filed Provisional Patent Application 61/613,546 filed on 03/21/12.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the United States Patent and Trademark Office patent file or records, but otherwise reserves all copyrights whatsoever.

### BACKGROUND

### Field of the Invention

Relating to improvements in devices mounted on the head of an individual providing useful functions to the same. More specifically, relating to improvements in Head Mounted Displays that provide a user with audio and or video stimuli.

Audio and or video sets exist in many different environments that serve the diverse requirements of their users. These range from the ubiquitous home computer, flat screen televisions, air traffic controllers to the displays present within the naval fleets patrolling the world's oceans. All of these have varying requirements in order to perform their functions and fulfill the needs of users. As time has brought more and more advancements in miniaturization as well as sound and video quality, industry has responded with newer implementations that enhance user perception of his or her desired environment.

These improvements in technology has prompted militaries, gamers and planners to move the audio and or video electronics into devices mounted on the head of an individual; these devices are known as Head Mounted Displays or HMDs. There are many HMDs available in the marketplace for gaming, military training, simulation and other uses; however, some HMDs are combat ready and because of the sensitive nature of the technologies present therein are unavailable to the general public but can be purchased by militaries globally to provide a useful audio and or video presentation.

Typically, HMDs use an optical device providing a user with an image directed backwards onto the eyes of the user or floating in the optical device itself; this of course does not permit another person from visualizing the images created by the HMD video device. This because the person would have to have another eyepiece to see the same image and would have to have a network connection receiving the images identical to the primary user.

One of the many problems associated with the aforementioned system is that an HMD suffers from not having an infinite focus on a displayed image. In other words, current HMD technologies use non crisp image technologies so that a user has to suffer through poor visualization. Thus, each head set would have to be singly designed and constructed for each particular user. As a result, higher costs would be imposed on buyers of these devices in order to tailor make each and every HMD.

Additionally, HMD wearers can get very tired of those that have an optical device providing floating or eye image projection because users have to constantly maintain an unnatural focus close to his or head performance. This can precipitate drastically reduced performance that can negatively effect the outcome of the HMDs original purpose. In a military, air traffic control or similar situation that depends on prompt response to changing situations any reduction in the ability of personnel to comprehend and react accordingly is simply not acceptable.

Thus, there needs to be solutions that overcome these deficiencies; these are provided in the instant invention as described below.

### BRIEF SUMMARY OF THE INVENTION

A head mounted display system comprising a hollow support structure having an opening for insertion of a user head a forward faceplate integrated with a front of the hollow support structure and a light projection device connected to the hollow support structure such that the light projection device displays an image on the forward faceplate when activated. A circuit device IS attached to the hollow support structure and in communication with the light projection device. An audio device is also attached and it is also is in with a circuit device. The forward faceplate is a matte screen or a shutter device. The shutter device is Citala shutter. The shutter device is selected from a group comprising: Flexible Polymer Display, Switchable Smart Glass, Switchable Smart Film, Electric Glass, and Electric Film. The light projection device is a SHOWWX+TM Laser Pico Projector Display Performance microvision laser projector. The light projection device is a microvision laser projector.

An electronic audio video display apparatus comprising a head mounting and displaying device having a faceplate section having a forward faceplate integrated with a front of the faceplate section attached to a backwards head support section housing a light projection device connected to the head mounting and display device such that the light projection device displays an image on the forward faceplate when activated. A circuit device is attached to the head mounting and displaying device and in communication with the light projection device and an audio device in communication with a circuit device. The circuit device is attached to the head mounting and displaying device and in communication with the light projection device such that an image is displayed on the forward faceplate and an audio device is in communication with the circuit device such that audio is transmitted from the circuit device to the audio device for user interaction at the audio device. Herein the audio device is an earphone and the forward faceplate is a shutter device. The forward faceplate is selected from the group comprising: Flexible Polymer Display, Switchable Smart Glass, Switchable Smart Film, Electric Glass, electric shutter, and Electric Film.

A video production system a laser projector having a controller connected thereto for displaying images to a connected shutter screen. The light projection device is a SHOWWX+TM Laser Pico Projector Display Performance microvision laser projector. The shutter is selected from a group comprising: Flexible Polymer Display, Switchable Smart Glass, Switchable Smart Film, Electric Glass, electric shutter, and Electric Film.

### BRIEF DESCRIPTION OF THE SEVERAL VIEWS OF THE DRAWINGS

FIG. 1 illustrates an embodiment of a user having a Head Mounted Display HMD for presentation of images on the interior faceplate/shutter of the HMD.

FIG. 2a illustrates an embodiment of a faceplate/shutter of a Head Mounted Display HMD where the faceplate/shutter is shown integrated with the HMD.

FIG. 2b illustrates an embodiment of a faceplate/shutter of a Head Mounted Display separate from the HMD.

FIG. 2c illustrates an embodiment of an opening of a Head Mounted Display HMD for insertion of the faceplate/shutter.

FIG. 3a illustrates an embodiment of the system utilized to create a present the image on the Head Mounted Display faceplate/shutter.

FIG. 3b illustrates an embodiment of the system having a list of items utilized in the circuit of FIG. 3a.

FIG. 4 illustrates an embodiment of the HMD having two helmets including a forward ‘faceplate section’ and a rear ‘helmet section.’

### DETAILED DESCRIPTION OF THE INVENTION

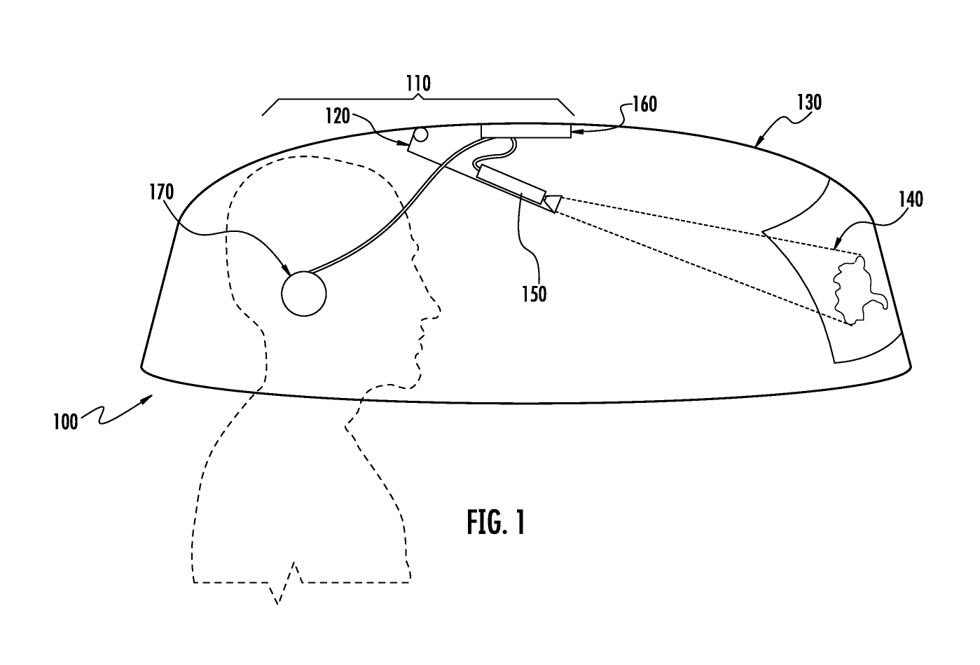

FIG. 1 illustrates an embodiment of a user having a Head Mounted Display HMD for presentation of audio to the user and images onto the interior faceplate/shutter of the HMD. The HMD 100 is shown having an audio and video production device 110, a plastic holding device 120, a plastic helmet device 130, a faceplate/shutter 140, a video production device 150, a circuit device 160 and audio listening device 170. The audio and video production device 110 is made up of a holding device 120, video production device 150, a circuit device 160 and audio listening device 170. The circuit device 160 has all of the electronics, controllers, power supply and interface mechanisms that facilitate the production of audio and video for the HMD.

To produce the audio and video as herein described requires electronics; these are provided through the aegis of a circuit device 160 that is located on the interior surface of the helmet device 130 where it is bolted down, adhesively connected or similarly attached to the helmet device 130; an alternative way of attaching the circuit device 160 is through the use of an additional mounting device or ledge for this arranged at the interior top portion of the helmet 130 that is integrated with or attached to the helmet device 130.

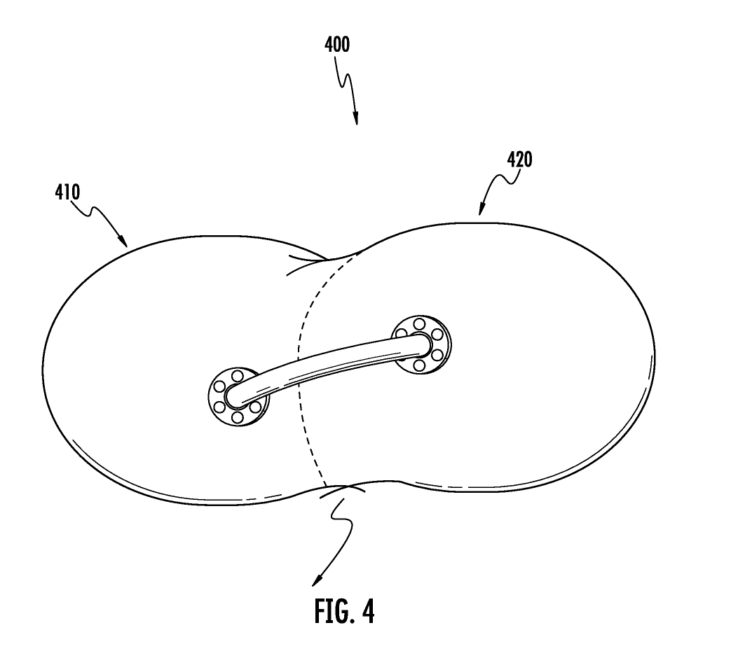

The helmet device 130 is an oblong hollow shell having a curved front with a vacant portion for the insertion of a faceplate/shutter 140 and a vacant portion for a user to place his head through; additionally, the back of the helmet device 130 similarly curves backwards forming a symmetric and clean appearance. In an interior portion of the helmet device, one can find the video production device 150 having a laser projection system that throws an image onto the faceplate/shutter 140. It is located on a holding device 120 that has the video production system bolted, adhesively connected or similarly attached to it. The helmet can also be arranged as two pieces with rubber light blocking portions attached thereto with adhesives or bolts connecting the two pieces and light blocking portions as shown in FIG. 4.

This holding device 120 is a plastic ledge extending from the interior surface of the HMD; it is disposed and designed in such a fashion that there is sufficient area to support the video production system 150 in an angled manner for the presentation of images on to the interior surface of the faceplate/shutter 140. This video production system 150 is in communication with circuit device 160 so as to transmit and receive all necessary command, status and other protocols necessary for accomplishing the herein described goals. Additionally, circuit device 160 is in communication with audio listening device 170 for the production of audio to the user. The audio listening device 170 are a set of two earphones that are arranged with support members for easy user access to the aforementioned.

The communication between the circuit device 160 and video production device 150 as well as audio listening device 170 is typically through wired communication; alternatively, wireless communication is envisioned through the use of antennas in at least two of the devices (always including the circuit device 160) of the three. Various protocols are in existence today such as bluetooth or wifi wireless technologies that are useable for this purpose. Of course a tailor made wireless communication protocol is also envisioned so as to protect the data flowing back and forth between the devices on the HMD.

It should be appreciated that the helmet comes with sufficient support structure typical for helmet devices of this sort. Thus, whilst not shown in the drawings it is understood that foam, plastic inserts and similar such devices are connected to the interior surface of the helmet so as to stabilize the helmet on a user's head and cushion his head for easy use of the HMD; further cushioning is arrayed about the audio device 170, wiring, mounting device 120, circuit device 160 and any other part of the HMD where such would be useful for user comfort and control of the HMD.

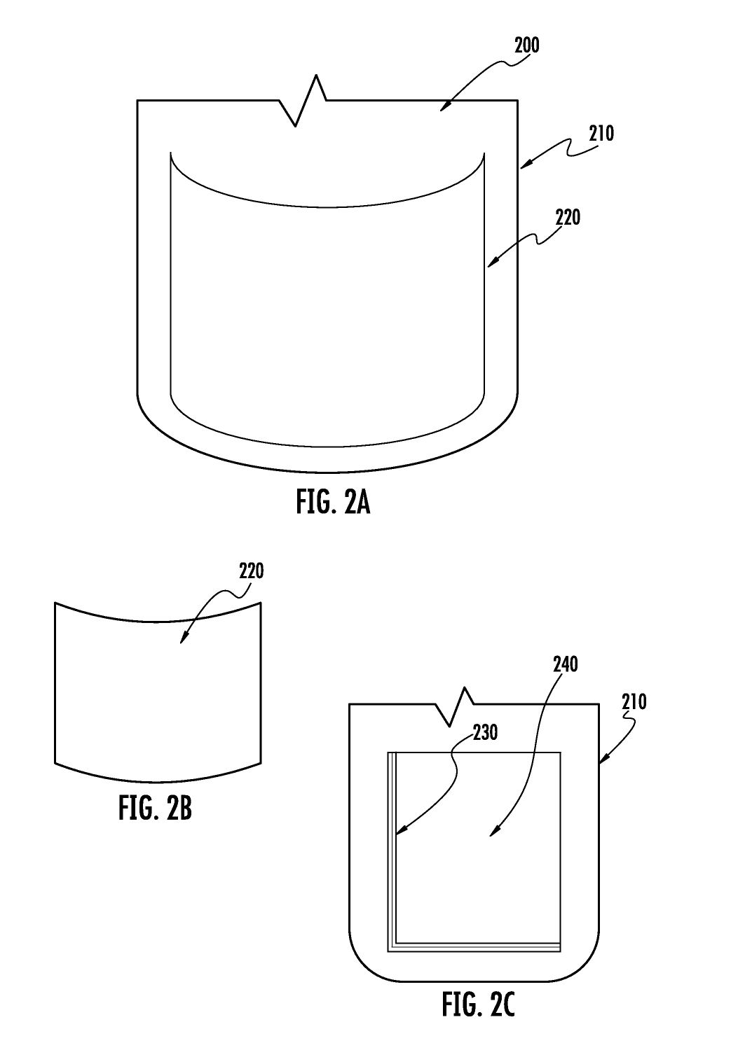

FIG. 2a illustrates an embodiment of a faceplate/shutter of a Head Mounted Display HMD where the faceplate/shutter is shown integrated with the HMD. The HMD helmet 200 is shown with a portion of the front 210 of the helmet device 200 shown in an exploded view. A faceplate/shutter 220 is shown in the figure as it is mounted in the front portion of the helmet device 200. Adhesives, bolts or similar attachment devices are utilized to keep the faceplate/shutter 220 in place in a vacant portion of the front portion 210 of the helmet device 200.

FIG. 2b illustrates an embodiment of a faceplate/shutter of a Head Mounted Display separate from the HMD. This is formed from an electric film or optical shutter manufactured from Citala Corporation. It is a device that opens or closes its operation based upon the powering of the device using a control device. In this implementation the control device is found on the circuit device 160 shown in FIG. 1.

FIG. 2c illustrates an embodiment of an opening of a Head Mounted Display HMD for insertion of the faceplate/shutter. The front 210 of a HMD 200 is shown having a vacant portion 240 on its surface. A sufficient depression is formed along the interior surface of the edges 230 so as to permit insertion of the faceplate/shutter 220 therein. Attachment devices such as bolts, adhesives, or similar devices are used to keep the faceplate/shutter in place. Alternatively, the device is kept in place through the simple use of the mechanical force of the plastic; i.e., the faceplate/shutter 220 is forced into the vacant portion 240 through the bending of its surface and that of the front of the HMD 200 thereby facilitating its attachment.

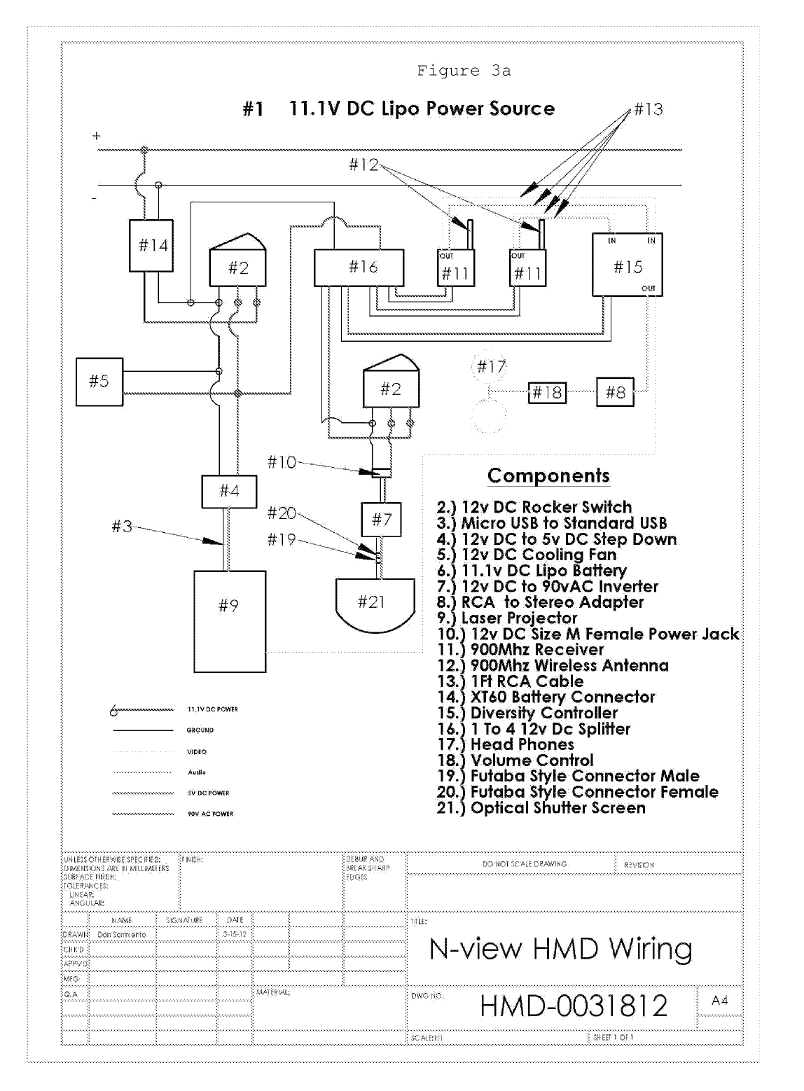

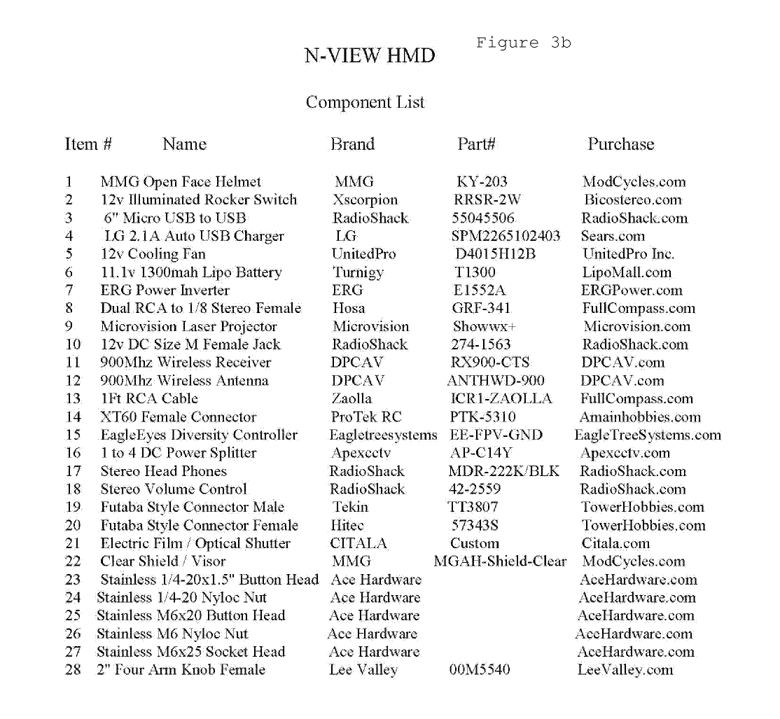

FIG. 3 illustrates an embodiment of the system utilized to create a present the image on the Head Mounted Display faceplate/shutter. It should be appreciated that a HMD is disclosed having a faceplate with two separate options (A & B) described below. The HMD is enclosed in a helmet having various parts such as cushioning for the head and ears as well as electronics designed to process images or video to the surface of an interior faceplate. Audio is also presented to speakers located in suitable depressions for the ears of a user.

### Prototype

The helmet in its prototype form 400 has a helmet section 410 and a forward faceplate section 420 described as two separate devices as shown in FIG. 4. It should be appreciated that the entire device also admits of an integral implementation. The particular choice of integral or separate components is dependent upon the needs of the implementation. The faceplate is attached in the forward section of the device by bolting or adhesive application to auxiliary components that further attach to the helmet section. In either case it should be appreciated that two ‘helmet sections’ have been attached together to form an integral system through the use of bolts, adhesives, rubber filler and similar such devices. A first helmet called the ‘helmet section’ 410 houses most of the electronics of the device and a second helmet dubbed the ‘faceplate section’ 420 houses the MATTE SCREEN of OPTION A or the OPTICAL SHUTTER of OPTION B. The faceplate section is forward of the helmet section; this helmet has had its back cut out so as to admit viewing of the user that has mounted his head in the helmet section using cushions and other support structures; once mounted the user can view the faceplate in the faceplate section as further shown in the drawings.

### Faceplate Screen or Shutter

Situated in the forward section of the faceplate section is a concave slab of material shaped to meet a corresponding section of the ‘faceplate section’ helmet. This concave slab of material is a screen or shutter attached to the top of the faceplate helmet section in a forward open compartment thereof through the use of an adhesive or of similar attachment mechanisms such as bolts, screws or similar devices. The screen or shutter is oriented in such a fashion so as to be disposed directly in front of a user once the helmet has been placed upon the head of an individual. Typically, this involves situating it a several centimeters in front of the user's face in a generally vertical fashion though any particular angle of attack to the horizontal would suffice as long as it makes the user able to effectively view the image or video on the screen or shutter.

Option A:

A first option has a screen with a matte opaque faceplate that has been created from a clear faceplate that has been painted. A microvision laser projector or a digital light projector, a digital image projector or other light projection device displays an image or video on this painted faceplate omitting the functionality described below.

Option B:

A second option has a clear faceplate made of electric film such as an optical shutter screen as shown in item 21. Manufactured by Citala, this optical shutter has the property of being able to be switched between the open and closed position such that light may pass therethrough. Inventor has discovered that a laser projector system such as that manufactured by microvision (item number #9) when activated presents a holographic type image or video upon the opening (transparent shutter) of the Citala Optical shutter and a solid image or video upon the closing of the Optical shutter so that a solid image or video appears on a opaque background. To accomplish this goal applicant used the electronic components as described in the accompanying images, drawings and schematic.

### Electronics

Powering the entire configuration is an 11.1 v DC Power source that is connected to a rocker switch (2) via an XT60 batter connector (14); the rocker switch (2) is further connected to a cooling fan (5) and to a 12 v DC to 5 v DC Step down using a charger (4). This Step down device is connected via a micro USB to standard USB connector to a Microvision laser (9) projector that illuminates the interior concave surface of the screen or shutter as described previously. An input of the rocker switch (2) is connected 1 to 4 12 v dc splitter (16). The splitter is connected to two 900 mhz receivers (11) a diversity controller (15) and a second 12 v DC rocker switch (2). This second switch (2) is further connected to a 12 v dc size M Female Power jack (10) that is connected to a 12 v DC to 90 v AC inverter (7). Further connection is to a female (20) to male (19) Futaba style connectors to the shutter screen (21). This second switch can thereby activate and deactivate the shutter screen from opaque to transparent operation.

In this transparent operation and with the activation of the first rocker switch (2) the microvision laser projector can project a laser image or video onto the shutter screen in opaque mode or in ‘holographic’ mode it can project a floating image or video on the open shutter transparent screen when that second rocker switch is placed in transparent mode. The receivers (11) have antennas (12) to receive audio and video data that are being broadcast in from an outside source. This data is outputted from the 900 mhz receivers (11) via 1 ft RCA cable into ports of the diversity controller (15) as shown. The video information is communicated to the microvision laser (9) and the audio output information is send to an RCA to stereo adapter (8). A volume control (18) is connected to this stereo adapter and finally to two headphones (17). In this fashion, audio and video data can be piped into the helmet device; additionally, the holographic shutter screen system is capable of displaying a floating type holographic image or video upon an open shutter and an image or video upon an opaque background when the shutter is closed.

### Microvision Laser Projector

Microvision Laser Projector/Microvision Laser Projection Engine produces on the inner surface of the faceplate a Floating Video or Holographic Video of a 480 p DVD Quality video device. The laser projector is a true Red, Green, Blue, Laser Engine. The words image or video for the output of the Laser Projection engine should be understood to be a 480 p DVD quality output video.

Projection Engine Details and Specs

### SHOWWX+TM Laser Pico Projector Display Performance

### Resolution: WVGA (848×480)

### Brightness: 15 Lumens

### Aspect Ratio: 16:9 Widescreen

Focus: No user focus adjustment needed. Image is always in focus, even on curved surfaces
Refresh Rate: 60 Hz (nominal)

### Color Gamut: >200% NTSC

### Contrast Ratio: >5,000:1

Throw Ratio: 1:1 (projection distance/image diagonal)
Image size: 150 mm to 2500 mm (6 in to 100 in)

### Projection Distance: 150 mm to 2500 mm (6 in to 100 in)

Regulatory: Class 2 laser product.1

### Screen Info

### Citala APDTM V6 Material/Optical Shutter

Also known as the following

### Flexible Polymer Display, Switchable Smart Glass, Switchable Smart Film,

### Electric Glass, Electric Film

Construction and Operation:

Citala displays are durable plastic laminates consisting of a our Onyx material sandwiched between two plastic substrates. Each substrate has a conductive coating on the inner surface forming the two electrodes. This conductive coating is transparent and very thin. One of these conductive layers is etched with a pattern according to the customer's requirements and is called the ELECTRODE layer. The other is a continuous unpatterned sheet conductor called the COMMON layer. To provide color in a display, a bright fluorescent colored reflector is laminated behind the cell.

When an electric field is applied across the cell (i.e. between ELECTRODE and COMMON), the Onyx material allows the light to pass through the cell to the colored reflector and back out to the viewer with very little absorption, resulting in a bright display. In the OFF state, the Onyx material strongly absorbs and scatters incoming light so that the display appears both dark and color neutral.

Thus the deficiencies found in the prior art have been overcome. Specifically, through the use of the microvision projector a infinite focus image is presented on the screen regardless of the size of the helmet or vision of the user. Further, the use of a optical shutter system overcomes the problem of visualizing the image on an optical device close to the user's head that can cause tiredness.

The instant invention has been shown and described herein in what is considered to be the most practical and preferred embodiment. It is recognized, however, that departures may be made therefrom within the scope of the invention. The invention has thus been described in such clear and precise terms as to enable one of ordinary skill in the art to understand its fundamental principles.

I claim:

1. A head mounted display system comprising:
a hollow support structure having an opening for insertion of a user head
a forward faceplate integrated with a front of the hollow support structure and
a light projection device connected to the hollow support structure such that the light projection device displays an image on the forward faceplate when activated.

2. The head mounted display system of claim 1, further comprising:
a circuit device attached to the hollow support structure and in communication with the light projection device.

3. The head mounted display system of claim 1, further comprising:
an audio device.

4. The head mounted display system of claim 3, wherein the audio device is in communication with a circuit device.

5. The head mounted display system of claim 1, wherein the forward faceplate is a matte screen.

6. The head mounted display system of claim 1, wherein the forward faceplate is a shutter device.

7. The head mounted display system of claim 6, wherein the shutter device is Citala shutter.

8. The head mounted display system of claim 6, wherein the shutter device is selected from a group comprising: Flexible Polymer Display, Switchable Smart Glass, Switchable Smart Film, Electric Glass, and Electric Film.

9. The head mounted display of claim 1 wherein the light projection device is a SHOWWX+TM Laser Pico Projector Display Performance microvision laser projector.

10. The head mounted display of claim 1 wherein the light projection device is a microvision laser projector.

11. An electronic audio video display apparatus comprising:
a head mounting and displaying device having:
a faceplate section having a forward faceplate integrated with a front of the faceplate section attached to
a backwards head support section housing
a light projection device connected to the head mounting and display device such that the light projection device displays an image on the forward faceplate when activated.

12. The electronic audio video display apparatus of claim 11, further comprising:
a circuit device attached to the head mounting and displaying device and in communication with the light projection device.

13. The electronic audio video display apparatus of claim 11, further comprising:
an audio device in communication with a circuit device.

14. The electronic audio video display apparatus of claim 11, further comprising:
a circuit device attached to the head mounting and displaying device and in communication with the light projection device such that an image is displayed on the forward faceplate and
an audio device in communication with the circuit device such that audio is transmitted from the circuit device to the audio device for user interaction at the audio device.

15. The electronic audio video display apparatus of claim 14, wherein the audio device is an earphone.

16. The electronic audio video display apparatus of claim 11, wherein the forward faceplate is a shutter device.

17. The electronic audio video display apparatus of claim 11, wherein the forward faceplate is selected from the group comprising: Flexible Polymer Display, Switchable Smart Glass, Switchable Smart Film, Electric Glass, electric shutter, and Electric Film.

18. A video production system comprising:
a light projector having a controller connected thereto for displaying images to a connected shutter screen.

19. The video production system of claim 18, wherein the light projection device is a SHOWWX+TM Laser Pico Projector Display Performance microvision laser projector.

20. The video production system of claim 18, wherein the shutter is selected from a group comprising: Flexible Polymer Display, Switchable Smart Glass, Switchable Smart Film, Electric Glass, electric shutter, and Electric Film.
